(19) United States
(12) Patent Application Publication
(10) Pub. No.: US 2019/0258148 A1
(43) Pub. Date: Aug. 22, 2019

(54) LIGHT SOURCE DEVICE AND PROJECTOR

(71) Applicant: CASIO COMPUTER CO., LTD., Tokyo (JP)

(72) Inventor: Masahiro OGAWA, Tokyo (JP)

(21) Appl. No.: 16/280,714

(22) Filed: Feb. 20, 2019

(30) Foreign Application Priority Data
Feb. 21, 2018 (JP) 2018-028429
Nov. 30, 2018 (JP) 2018-225183

(51) Int. Cl. G03B 21/20; G02B 26/00

(52) U.S. Cl. CPC G03B 21/204; G03B 21/2066; G02B 26/008; G03B 21/2013

(57) ABSTRACT

A light source device emits combined light, using a plurality of light sources. The light source device includes first, second and third light sources, and first and second combining members. The first light source emits light of a first wavelength band. The third light source uses the light of the first wavelength band as excitation light and emits light of a third wavelength band which is fluorescent light. The second light source emits light of a second wavelength band which is different from the third wavelength band. The first combining member combines the light of the first wavelength band and the light of the third wavelength band. The second combining member combines the combined light obtained by the first combining member and the light of the second wavelength band. The combined light obtained by the second combining member enters a light guiding unit.

### CROSS-REFERENCE TO RELATED APPLICATIONS

This application is based on and claims priority under 35 USC 119 from Japanese Patent Application Nos. 2018-028429 filed on Feb. 21, 2018, and 2018-225183, filed on Nov. 30, 2018, the contents of which are incorporated herein by reference.

### FIELD OF THE INVENTION

The present invention relates to a light source device and a projector having the light source device.

### DESCRIPTION OF THE RELATED ART

JP-A-2011-13320 discloses a light source device having a light emitting plate, a first light source, and a second light source, and also discloses a projector having the light source device. In the light emitting plate, a phosphor layer is formed to emit light of a predetermined wavelength band by receiving excitation light. Light which the phosphor layer emits is light of a green wavelength band. The first light source is a laser emitter which emits light of a blue wavelength band as excitation light. The first light source emits the excitation light onto the phosphor layer and a transmission part of the light emitting plate. The second light source is a light emitting diode which emits light of a red wavelength band as light of a wavelength band different from the wavelength band of fluorescent light and the wavelength band of the excitation light.

The light source device of JP-A-2011-13320 uses laser light (light of the blue wavelength band) which is emitted from the first light source emit and has high directivity, fluorescent light (light of the green wavelength band) which is emitted from the phosphor layer when the phosphor layer is excited by the laser light, and light of the red wavelength band which is emitted from the light emitting diode and has directivity lower than that of the laser light. In this case, it is required to keep a necessary light quantity ratio which is the ratio of light quantities for light of the blue wavelength band, light of the green wavelength band, and light of the red wavelength band required in order to obtain a desired whiteness level (a white balance). However, in this light source device, since the number of optical members, such as condensing lenses, dichroic mirrors, and reflective mirrors, and the length of a light path for light of the red wavelength band are substantially the same as the number of optical members and the length of a light path for light of the green wavelength band, as compared to light of the green wavelength band, it may be more difficult to make light of the red wavelength band have luminance required for source light, due to loss in the optical members. For this reason, there are some problems such as a problem that when the balance of the quantities of light of the individual colors is considered, the whole of each image becomes dark and a problem that when high brightness is forcibly set, since the quantity of light of the red wavelength band is insufficient, the light quantity balance becomes bad.

The present invention was made in view of the above-mentioned circumstances, and an object of the present invention is to provide a light source device for emitting bright source light, and a projector having the light source device.

### SUMMARY OF THE INVENTION

A light source device emits combined light, using a plurality of light sources. The light source device includes a first light source, a third light source, a second light source, a first combining member, and a second combining member. The first light source is configured to emit light of a first wavelength band. The third light source is configured to use the light of the first wavelength band as excitation light and is configured to emit light of a third wavelength band which is fluorescent light. The second light source is configured to emit light of a second wavelength band which is different from the third wavelength band. The first combining member is configured to combine the light of the first wavelength band and the light of the third wavelength band. The second combining member is configured to combine the combined light obtained by the first combining member and the light of the second wavelength band. The combined light obtained by the second combining member enters a light guiding unit.

A light source device includes a first light source, a third light source, a fourth light source, a second light source, a first combining member and a second combining member. The first light source is configured to emit light of a first wavelength band. The third light source is configured to use the light of the first wavelength band as excitation light and is configured to emit light of a third wavelength band. The fourth light source is configured to emit light of the wavelength band of the same color as the color of light of the first wavelength band. The second light source is configured to emit light of a second wavelength band which is different from the third wavelength band. The first combining member is configured to combine light of the third wavelength band and light emitted from the fourth light source. The second combining member is configured to combine the combined light obtained by the first combining member and the light of the second wavelength band. The combined light obtained by the second combining member enters a light guiding unit.

### BRIEF DESCRIPTION OF THE DRAWING

FIG. 1 is a perspective view illustrating the external appearance of a projector according to an embodiment of the present invention.

FIG. 2 is a view illustrating functional blocks of the projector according to the embodiment of the present invention.

FIG. 3 is a plan view schematically illustrating the inner structure of the projector according to the embodiment of the present invention.

FIG. 4 is a view illustrating the relation between the light intensity ratio of light of a blue wavelength band, light of a green wavelength band, and light of a red wavelength band and light ray angle according to the embodiment of the present invention.

FIG. 5 is a view illustrating a phosphor wheel according to the embodiment of the present invention.

### DETAILED DESCRIPTION OF THE PREFERRED EMBODIMENT

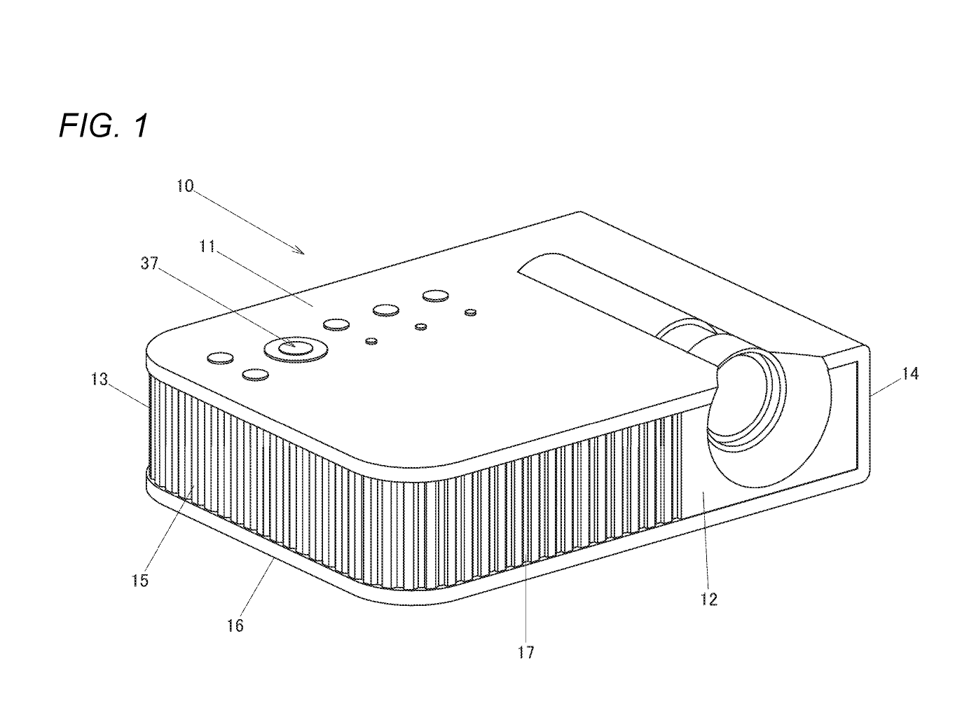

Hereinafter, an embodiment of the present invention will be described with reference to the drawings. FIG. 1 is a perspective view illustrating the external appearance of a projector 10. Also, in the present embodiment, the left and right of the projector 10 represent left and right with respect to a projection direction, and the front and rear of the projector represent the front and rear of the projector 10 in the direction toward a screen.

As shown in FIG. 1, the casing of the projector 10 has the approximate shape of a cube. The casing is formed of side panels composed of a front panel 12, a rear panel 13, a left panel 14, and a right panel 15, a top panel 11, and a bottom panel 16. The projector 10 has a projecting part on the left side of the front panel 12. Further, the front panel 12 has a plurality of air intake and exhaust holes 17. Also, the projector 10 has an Ir receiver (not shown in the drawings) for receiving control signals from a remote controller.

The top panel 11 has a key/indicator unit 37. This key/indicator unit 37 includes various keys and indicators such as a power switch, a power indicator for informing whether the power is on or off, a projection switch for switching projection on or off, and an overheat indicator for informing if a light source unit, a display element, a control circuit, or the like is overheated.

The rear panel 13 has an input/output connector part having a USB terminal, an image signal input D-SUB terminal for inputting analog RGB image signals, an S terminal, RCA terminals, an audio output terminal, and so on, and various terminals such as a power supply adapter plug, not shown in the drawings. Also, the rear panel 13 has a plurality of air intake holes.

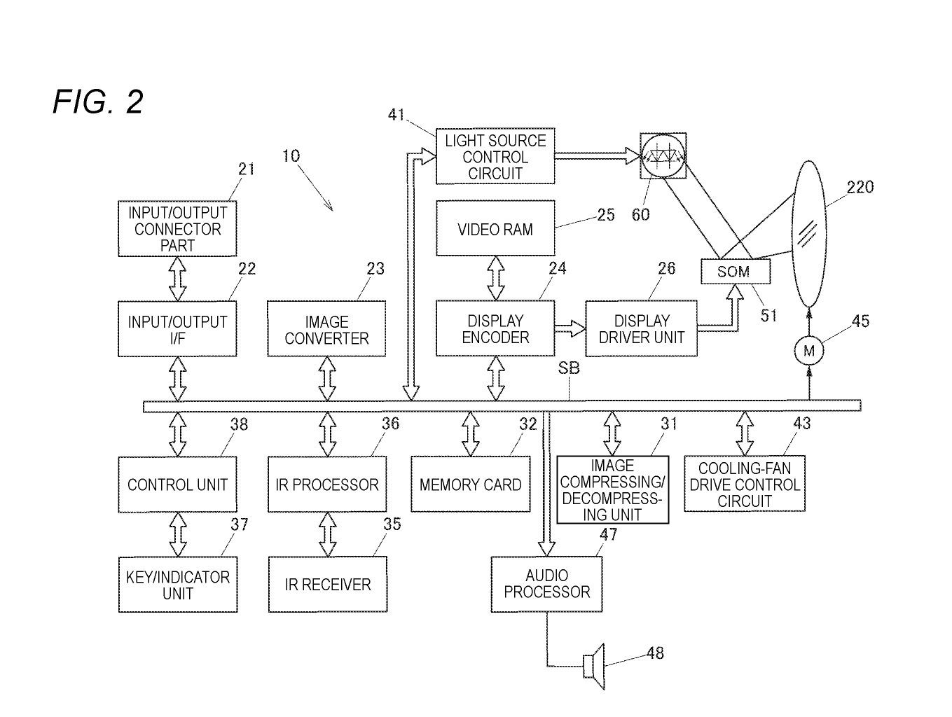

Now, a projector control unit of the projector 10 will be described with reference to the functional block diagram of FIG. 2. The projector control unit includes a control unit 38, an input/output interface 22, an image converter 23, a display encoder 24, a display driver unit 26, and so on.

The control unit 38 is for controlling the operations of individual circuits included in the projector 10, and is configured with a CPU, a ROM retaining operation programs such as various settings, a RAM usable as a work memory, and so on.

Also, the projector control unit performs control such that image signals of various standards input from an input/output connector part 21 are transmitted via the input/output interface 22 and a system bus (SB), and are converted into image signals of a predetermined format suitable for display by the image converter 23, and are output to the display encoder 24.

Also, after the input image signals are decompressed and are stored in a video RAM 25, the display encoder 24 generates video signals from the contents stored in the video RAM 25, and outputs the video signals to the display driver unit 26.

The display driver unit 26 drives a display element 51 which is a spatial optical modulator (SOM) at an appropriate frame rate corresponding to each image signal output from the display encoder 24. The projector 10 guides a flux of light emitted from a light source device 60 onto the display element 51 via a light source side optical system 170 to be described below, thereby forming optical images (image light) by the reflected light from the display element 51, and projects the images onto a screen (not shown in the drawings) via a projection side optical system 220 to be described below. Also, the projection side optical system 220 includes a movable lens group, which is driven for zoom adjustment and focus adjustment by a lens motor 45.

An image compressing/decompressing unit 31 performs data compression on luminance signals and color difference signals of image signals by processing such as ADCT and Huffman encoding, and performs a recording process of sequentially writing the compressed data in a memory card 32 which is a portable recording medium.

In a reproduction mode, the image compressing/decompressing unit 31 reads out the image data recorded in the memory card 32, and decompresses image data constituting a video in units of one frame, and outputs the decompressed image data to the display encoder 24 via the image converter 23. The image compressing/decompressing unit 31 performs a process of making it possible to display the video and the like based on the image data stored in the memory card 32.

The key/indicator unit 37 is composed of main keys, indicators, and so on which are installed on the top panel 11 of the casing. Operation signals of the key/indicator unit 37 are transmitted directly to the control unit 38. Key operation signals from the remote controller are received by an Ir receiver 35, and are demodulated by an IR processor 36, and the demodulated signals are output to the control unit 38.

Also, the control unit 38 is connected to an audio processor 47 via the system bus (SB). The audio processor 47 includes a sound source circuit such as a PCM sound source. In a projection mode and the reproduction mode, the audio processor converts audio data into analog data, and drives a speaker 48 such that the speaker outputs the sound at a volume.

Also, the control unit 38 controls a light source control circuit 41 which is a light source control unit. The light source control circuit 41 controls the light source device 60 such that the light source device emits light of the red wavelength band, light of the green wavelength band, and light of the blue wavelength band, whereby light of predetermined wavelength bands required for image generation is emitted from the light source device 60.

Further, the control unit 38 controls a cooling-fan drive control circuit 43 such that the cooling-fan drive control circuit performs temperature detection using a plurality of temperature sensors installed in the light source device 60 and so on, and controls the rotation speed of a cooling fan according to the results of the temperature detection. The control unit 38 controls the cooling-fan drive control circuit 43 such that the cooling-fan drive control circuit keeps rotating the cooling fan by a timer or the like even after the power of the main body of the projector is turned off, or performs control to turn off the power of the main body of the projector 10, or the like, depending on the results of temperature detection of the temperature sensors.

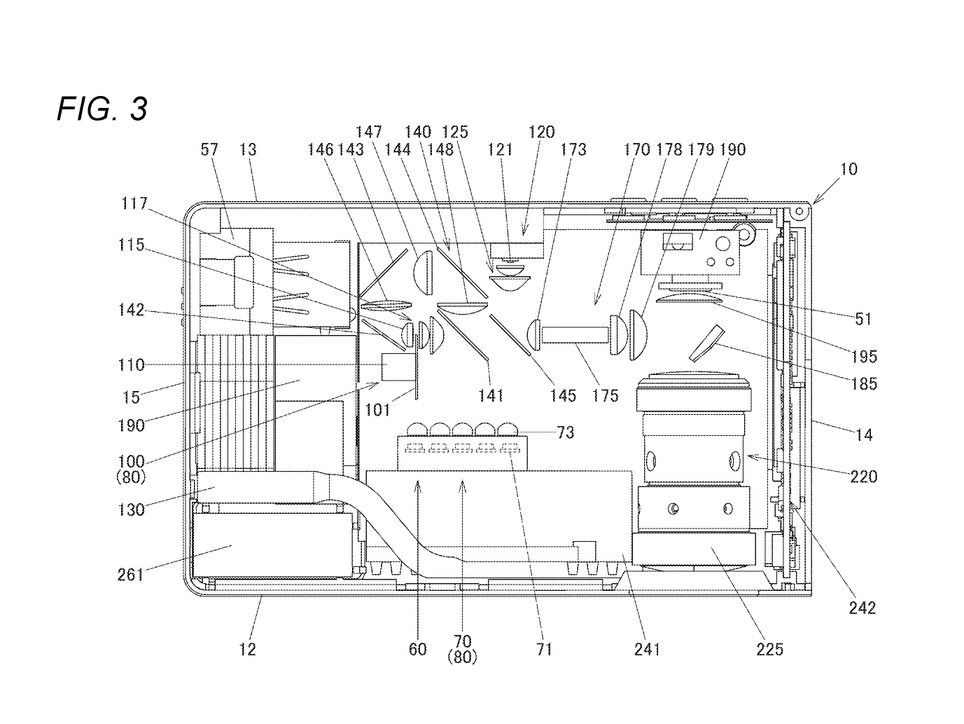

Now, the inner structure of the projector 10 will be described. FIG. 3 is a plan view schematically illustrating the inner structure of the projector 10. The projector 10 has the light source device 60 at an approximate center part, and has the projection side optical system 220 on one side of the light source device 60 close to the left panel. Between the projection side optical system 220 and the rear panel 13, the display element 51 is disposed. The display element 51 of the present embodiment is a DMD. Also, the projector 10 has a main control circuit board 241 between the light source device 60 and the front panel 12, and has a power control circuit board 242 between the projection side optical system 220 and the left panel 14.

Between the light source device 60 and the right panel 15, a power connector 57 and a heat sink 190 are disposed sequentially from the rear panel 13 side. The projector has a heat pipe 130 for guiding heat which is generated in an excitation light irradiation unit 70 and a phosphor wheel 101, and a cooling fan 261.

The light source device 60 includes the excitation light irradiation unit 70, a green light source unit 80, and a red light source unit 120. The excitation light irradiation unit 70 is disposed in the vicinity of the center of the projector 10. The green light source unit 80 is formed by the excitation light irradiation unit 70 and a fluorescent wheel unit 100. The red light source unit 120 is disposed in the vicinity of an optical guiding system 140.

The excitation light irradiation unit 70 includes a plurality of blue laser diodes 71 (a first light source) which is semiconductor light emitting elements disposed such that their optical axes are substantially parallel with the left panel 14 and the right panel 15, and collimator lenses 73 disposed on the optical axes of the blue laser diodes 71. Light of the blue wavelength band (light of a first wavelength band) which is emitted from the blue laser diodes 71 is limited to a predetermined diffusion range by the collimator lenses 73, thereby forming a flux of light. The blue laser diodes 71 are cooled by the heat sink 190.

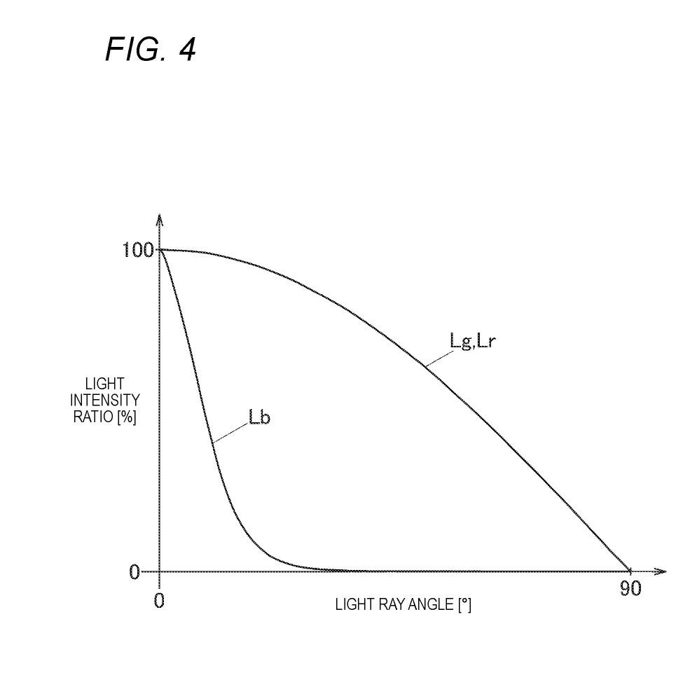

Herein, FIG. 4 is a view illustrating the relation and light ray angle of the light intensity ratio of light Lb of the blue wavelength band, light Lg of the green wavelength band, and light Lr of the red wavelength band. Since light Lb of the blue wavelength band which is emitted from the blue laser diodes 71 is light which is radiated from the blue laser diodes 71, it has a relatively small light ray angle and has high directivity.

Referring to FIG. 3 again, the fluorescent wheel unit 100 includes the phosphor wheel 101 (a third light source), a condensing lens group 117, and a condensing lens 115. The condensing lens group 117 and the condensing lens 115 are disposed with the phosphor wheel 101 interposed therebetween. The phosphor wheel 101 is a flat disc-like plate, and is disposed substantially in parallel with the right panel 15 and the left panel 14.

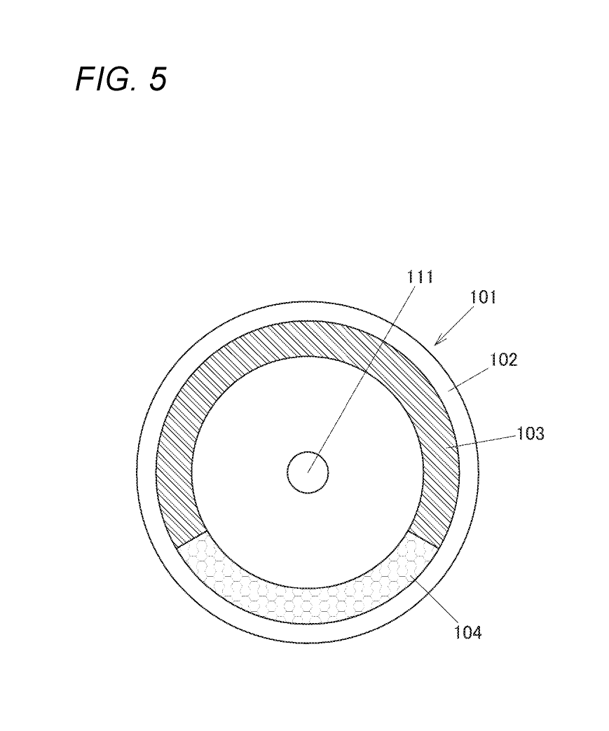

FIG. 5 is a view schematically illustrating the phosphor wheel 101. The phosphor wheel 101 includes a disc-like base 102 having surfaces subjected to mirror finishing. The phosphor wheel 101 has two segments, i.e. a fluorescent area 103 and a transmission area 104 formed in a line along the circumferential direction on the base 102. The fluorescent area emits light of the green wavelength band (light of a third wavelength band) as fluorescent light if it is excited by light of the blue wavelength band, and the transmission area transmits light of the blue wavelength band. As shown in FIG. 4, light Lg of the green wavelength band which is emitted as fluorescent light is diffuse light having a light ray angle larger than that of light Lb of the blue wavelength band. Therefore, as compared to light Lb of the blue wavelength band, the necessary light quantity for light Lg of the green wavelength band is smaller. The fluorescent area 103 is formed of a binder such as a silicon resin having high heat resistance and high transmissivity and a green phosphor uniformly dispersed in the binder. The phosphor wheel 101 is supported on a motor shaft 111, and is rotated by a motor 110 controlled by the light source control circuit 41.

The fluorescent area 103 receives light of the blue wavelength band emitted from the blue laser diodes 71, as excitation light, and emits fluorescent light of the green wavelength band from the excitation light incidence surface.

Referring to FIG. 3 again, the red light source unit 120 includes a red light source 121 (a second light source) whose optical axis is substantially parallel with the right panel 15 and the left panel 14, and a condensing lens group 125 disposed on the optical axis of the red light source 121. The red light source 121 is composed of a red light emitting diode. Therefore, the light source device 60 of the present embodiment is a hybrid type including the laser diodes (the blue laser diodes 71) and the light emitting diode (the red light source 121). The red light source 121 emits light of the red wavelength band (light of a second wavelength band). As shown in FIG. 4, substantially similarly to light Lg of the green wavelength band, light Lr of the red wavelength band which is emitted from the light emitting diode is diffuse light having a light ray angle larger than that of light Lb of the blue wavelength band. Since light Lg of the green wavelength band is excited by light Lb of the blue wavelength band which is laser light, the necessary light quantity for light Lr of the red wavelength band is smaller than that for light Lg of the green wavelength band. In FIG. 3, the emission angle of light of the red wavelength band is controlled within a predetermined diffusion range by the condensing lens group 125. Also, the red light source 121 is cooled by the heat sink 190.

The optical guiding system 140 is configured with a plurality of dichroic mirrors (a first dichroic mirror 141 and a second dichroic mirror 145), a plurality of reflective mirrors (a first reflective mirror 142, a second reflective mirror 143, and a third reflective mirror 144), and a plurality of condensing lenses 146, 147, and 148.

The first dichroic mirror (a first combining member) 141 is disposed on the optical axis of light of the blue wavelength band which is emitted from the excitation light irradiation unit 70 and on the optical axis of light of the green wavelength band which is emitted from the fluorescent wheel unit 100. The first dichroic mirror 141 includes a glass substrate, and a dichroic coating formed on one side of the glass substrate close to the excitation light irradiation unit 70. The first dichroic mirror has an AR (Anti-Reflection) coating formed on the other side, i.e. on the opposite side to the one side in order to prevent reflection of light. The first dichroic mirror 141 reflects light of the blue wavelength band toward the fluorescent wheel unit 100 by the dichroic coating formed on the one side, and transmits light of the green wavelength band emitted from the fluorescent wheel unit 100 toward the second dichroic mirror 145.

The first reflective mirror 142 is disposed on one side of the fluorescent wheel unit 100 close to the right panel 15. The first reflective mirror 142 is disposed on the optical axis of light of the blue wavelength band which is emitted from the fluorescent wheel unit 100, and reflects incident light of the blue wavelength band toward the second reflective mirror 143.

The second reflective mirror 143 is disposed on one side of the first reflective mirror 142 close to the rear panel 13. Further, between the first reflective mirror 142 and the second reflective mirror 143, the condensing lens 146 is disposed. The second reflective mirror 143 reflects light of the blue wavelength band reflected by the first reflective mirror 142 and concentrated by the condensing lens 146, toward the third reflective mirror 144.

The third reflective mirror 144 is disposed on one side of the second reflective mirror 143 close to the left panel 14. Further, between the second reflective mirror 143 and the third reflective mirror 144, the condensing lens 147 is disposed. The third reflective mirror 144 reflects light of the blue wavelength band reflected by the second reflective mirror 143 and concentrated by the condensing lens 147, toward the first dichroic mirror 141.

Between the third reflective mirror 144 and the first dichroic mirror 141, the condensing lens 148 is disposed. The first dichroic mirror 141 reflects light of the blue wavelength band reflected by the third reflective mirror 144 and concentrated by the condensing lens 148, toward the second dichroic mirror 145 by the dichroic coating.

The second dichroic mirror (a second combining member) 145 is disposed on the optical axis of light of the blue wavelength band and light of the green wavelength band which are emitted from the first dichroic mirror 141 and on the optical axis of light of the red wavelength band which is emitted from the red light source unit 120. The second dichroic mirror 145 transmits light of the blue wavelength band and light of the green wavelength band, and reflects light of the red wavelength band. Therefore, the second dichroic mirror 145 transmits light of the blue wavelength band and light of the green wavelength band emitted from the first dichroic mirror 141, toward a condensing lens 173 of the light source side optical system 170. Also, the second dichroic mirror 145 reflects light of the red wavelength band emitted from the red light source unit 120, toward the condensing lens 173. Therefore, the light of the blue wavelength band, the light of the green wavelength band, and the light of the red wavelength band are combined, and are guided to the light source side optical system 170, by the optical guiding system 140. As described above, in the order of light of the blue wavelength band, light of the green wavelength band, and light of the red wavelength band, the total numbers of components of the first dichroic mirror 141, the second dichroic mirror 145, the plurality of reflective mirrors 142, 143, and 144, and the condensing lenses 146, 147, 148, and 115 (including the condensing lenses 117 and 125) which reflect or transmit light of the individual bands decrease, and the lengths of the light paths along which light of the individual bands pass until the light of the individual bands is combined decrease.

The light source side optical system 170 includes condensing lens 173, 178, and 179, a light tunnel (a light guiding unit) 175, an irradiation mirror 185, a condensing lens 195. The condensing lens 195 is also a part of the projection side optical system 220.

Light of the individual bands, i.e. light of the blue wavelength band, light of the green wavelength band, and light of the red wavelength band guided to the light source side optical system 170 is concentrated by the condensing lens 173, and enters the light tunnel 175. The light entering the light tunnel 175 is converted into light having a uniform area density, and then is concentrated by the condensing lenses 178 and 179. The light concentrated by the condensing lens 179 is reflected toward the display element 51 by the irradiation mirror 185. The light reflected by the irradiation mirror 185 is concentrated onto the display element 51 by the condensing lens 195.

The source light concentrated onto the image formation surface of the display element 51 by the light source side optical system 170 is reflected as projection light to the projection side optical system 220 by the image formation surface of the display element 51. The projection side optical system 220 is configured with the condensing lens 195, and fixed lenses and movable lenses which are provided in a lens barrel 225. The projection light emitted from the display element 51 is projected onto a screen via the projection side optical system 220.

Since the projector 10 is configured as described above, if light is emitted from the excitation light irradiation unit 70 and the red light source unit 120 at appropriate timings while the phosphor wheel 101 is rotated, the light of the blue wavelength band, the light of the green wavelength band, and the light of the red wavelength band enter the display element 51 via the optical guiding system 140 and the light source side optical system 170. Therefore, the DMD which is the display element 51 can display light of the individual colors in a time division manner according to data, thereby capable of projecting color images onto the screen.

(First Modification)

Now, a first modification will be described. In the above-described embodiment, light Lb of the blue wavelength band (light of the first wavelength band) enters the first dichroic mirror 141 (the first combining member) from one side, and is reflected by the first dichroic mirror 141, and enters the first dichroic mirror 141 from the other side again, and is reflected by the first dichroic mirror 141. However, the first dichroic mirror 141 is not limited to the configuration for reflecting light of the first wavelength band. The first dichroic mirror may be configured to transmit light of the first wavelength band.

Hereinafter, a specific configuration will be described. Light of the first wavelength band enters the first dichroic mirror from one side, and passes through the first dichroic mirror, and enters the first dichroic mirror from the other side again, and passes through the first dichroic mirror. In this case, after the light of the blue wavelength band (light of the first wavelength band) passes through the first dichroic mirror, the light passes through the transmission area of the phosphor wheel, and is guided to the first dichroic mirror again by a plurality of reflective mirrors. The first dichroic mirror transmits light of the first wavelength band and reflects light of the green wavelength band (light of the third wavelength band). Further, the second dichroic mirror (the second combining member) transmits light of the first wavelength band and light of the green wavelength band (light of the third wavelength band) reflected by the first dichroic mirror, and reflects light of the red wavelength band (light of the second wavelength band).

Although the light source device 60 and the projector 10 have been described above, the present invention is not limited to the above-described embodiment. For example, in FIG. 3, as the first dichroic mirror 141, a plate-like mirror configured by forming a dichroic coating on one side of a glass substrate is shown; however, any other single member having a different three-dimensional shape may be used as long as the corresponding member can separate and combine light of the blue wavelength band.

Also, the reflective mirrors 142, 143, and 144 and the condensing lenses 146, 147, and 148 are disposed in the optical guiding system 140; however, the arrangement and number of such components can be appropriately changed as long as the corresponding components can guide light of the blue wavelength band, separated from light of the green wavelength band and guided once by the first dichroic mirror 141 and the phosphor wheel 101, to the first dichroic mirror 141 again in order to combine the light of the blue wavelength band with the light of the green wavelength band. For example, the optical axis of light of the blue wavelength band having passed through the fluorescent wheel unit 100 may be changed by the first reflective mirror 142 and the third reflective mirror 144 such that the light enters the first dichroic mirror 141 without being reflected by the second reflective mirror 143.

Also, in the phosphor wheel 101, as the fluorescent area 103, an area for emitting light of the green wavelength band and an area for emitting light of a yellow wavelength band may be formed side by side along the same direction. According to this configuration, the light source device 60 can emit light of the yellow wavelength band emitted from the fluorescent area excited by light of the blue wavelength band emitted from the excitation light irradiation unit 70, together with light of the blue wavelength band, light of the green wavelength band, and light of the red wavelength band, in a time division manner, and can be used as a light source for the projector 10 to display high-luminance images.

(Second Modification)

Now, a second modification will be described. In the above-described embodiment, the blue laser diodes 71 serves as the light source of excitation light for exciting the fluorescent area 103 formed in the phosphor wheel (the third light source) 101 such that the fluorescent area emits fluorescent light, and light which is emitted from the blue laser diodes 71 is used as blue light. However, in the present modification, the blue laser diodes 71 are configured to serve only as the light source of excitation light for exciting the fluorescent area 103 formed in the phosphor wheel (the third light source) 101 such that the fluorescent area emits fluorescent light. In this case, the fluorescent area 103 formed in the phosphor wheel (the third light source) 101 extends over the entire circumference of 360°.

In order not to use the blue laser diodes 71 as the light source of the blue wavelength band to be used as projection light, a light emitting diode (a fourth light source) for emitting blue light (light of the wavelength band of the same color as the color of light of the first wavelength band) is provided at a position facing the blue laser diodes 71 with reference to the first dichroic mirror 141. Also, the excitation light source is not limited to the blue laser diodes 71, and for example, ultraviolet laser diodes may be used. According to this configuration, since the second reflective mirror 143 and the third reflective mirror 144 become unnecessary, the configuration is simplified, and it is possible to reduce the size of the whole of the light source device.

As described above, the light source device 60 and the projector 10 of the present embodiment include the first light source (the blue laser diodes 71) for emitting light of the first wavelength band (light of the blue wavelength band), the second light source (the light emitting diode) for emitting light of the second wavelength band (light of the red wavelength band) for which the necessary light quantity is smaller than that for light of the first wavelength band, and the optical guiding system 140 for guiding the light of the second wavelength band along a path shorter than that for the light of the first wavelength band, and combining the light of the first wavelength band and the light of the second wavelength band.

Since the light paths shorten in the descending order of the necessary quantities for light of the red wavelength band, light of the green wavelength band, and light of the blue wavelength band, it is possible to reduce loss of light for which the necessary light quantity is small, in the light source device 60, and it is possible to display bright images with projection light. Also, since it is possible to improve brightness without increasing the number of light sources, it is possible to configure the light source device 60 and the projector 10 capable of emitting bright source light, in small sizes.

Also, the light source device 60 includes the third light source (the phosphor wheel 101) for emitting light of the third wavelength band (light of the green wavelength band) for which the necessary light quantity is smaller than that for light of the first wavelength band and is larger than that for the light of the second wavelength band, and the optical guiding system 140 guides light of the third wavelength band along the light path shorter than that for light of the first wavelength band and longer than that for light of the second wavelength band, and combines the light of the third wavelength band with light of the first wavelength band and light of the second wavelength band. According to this configuration, with respect to the plurality of kinds of light which the light source device 60 emits, it is possible to preferentially reduce loss of light for which the necessary light quantity is smaller, so it is possible to emit bright source light. As described above, in this application, in order to keep the ratio of R, G, and B light quantities required to secure a whiteness level (a white balance), i.e. the ratio of necessary light quantities, the distance from the light guiding unit to the red light source is set to be shorter than the distances from the light guiding unit to the other light sources, such that loss in the red light quantity is suppressed. In other words, it is possible to reduce loss during surface reflection and transmission of the optical elements such as the dichroic mirrors which are disposed on the light path.

Also, in the light source device 60 of the present embodiment, the first light source is the laser diodes, and the second light source is the light emitting diode, and the third light source is the rotary phosphor wheel 101 which has the fluorescent area 103 for emitting fluorescent light as light of the third wavelength band and the transmission area 104 for transmitting light of the first wavelength band, formed in a line along the circumferential direction. Therefore, it is possible to configure the high-luminance light source device 60 using a small number of self-luminous elements.

Also, the light source device 60 including the first dichroic mirror 141 for reflecting or transmitting light of the first wavelength band and transmitting or reflecting light of the third wavelength band, the plurality of reflective mirrors 142, 143, and 144 for guiding the light of the first wavelength band to the other side of the first dichroic mirror 141, and the second dichroic mirror 145 for transmitting the light of the first wavelength band and the light of the third wavelength band, and reflecting light of the second wavelength band, and combine the light of the first wavelength band, the light of the second wavelength band, and the light of the third wavelength band can reduce loss of the light of each wavelength band on the light path, using a small number of optical members.

Also, in the light source device 60, the total numbers of components of the first dichroic mirror 141, the second dichroic mirror 145, and the plurality of reflective mirrors 142, 143, and 144 which reflect or transmit light of the individual bands decrease in the order of light of the first wavelength band, light of the third wavelength band, and light of the second wavelength band. The light source device 60 can reduce loss of light for which the necessary light quantity is small, before combining.

Also, in the light source device 60, light of the first wavelength band is light of the blue wavelength band, and light of the second wavelength band is light of the red wavelength band, and light of the third wavelength band is light of the green wavelength band. The light source device 60 can be used as a light source for projecting color images.

Also, in general, it is difficult for the light separation characteristic of a dichroic mirror to transmit or reflect all of light of a specific wavelength. Therefore, when a dichroic mirror transmits or reflects light emitted from the excitation light irradiation unit, a part of the emitted light may be reflected or transmitted by the dichroic mirror, thereby reaching the red light source unit. However, according to the configuration of the present embodiment, since the red light source (the second light source) 121 is not on the opposite side of the first dichroic mirror 141 for reflecting excitation light from the blue laser diodes (the first light source) 71, a part of excitation light does not reach the red light source (the second light source) 121. Therefore, even in the case where the projector is used for a long time, an influence such as decrease in the lives of the optical elements of the red light source unit 120 does not occur. Therefore, it becomes possible to use aspheric plastic lenses made of resin likely to deteriorate due to irradiation with excitation light, instead of aspheric glass lenses.

Also, in the present embodiment, as the light guiding unit, the light tunnel 175 is used; however, the light guiding unit is not limited to thereto. As the light guiding unit, a glass rod or a micro-lens array may be used.

The above-described embodiments have been presented by way of example only, and are not intended to limit the scope of the inventions. The above-described novel embodiments may be embodied in a variety of other forms; furthermore, various omissions, substitutions and changes in the above-described embodiments may be made without departing from the concept of the inventions. The above-described embodiments and modifications thereof are included in the scope and gist of the inventions, and are included in the scope of inventions disclosed in claims and equivalents of them.

What is claimed is:

1. A light source device which emits combined light, using a plurality of light sources, comprising:
a first light source that is configured to emit light of a first wavelength band;
a third light source that is configured to use the light of the first wavelength band as excitation light and that is configured to emit light of a third wavelength band which is fluorescent light;
a second light source that is configured to emit light of a second wavelength band which is different from the third wavelength band;
a first combining member that is configured to combine the light of the first wavelength band and the light of the third wavelength band; and
a second combining member that is configured to combine the combined light obtained by the first combining member and the light of the second wavelength band,
wherein the combined light obtained by the second combining member enters a light guiding unit.

2. The light source device according to claim 1, wherein:
to keep the ratio of necessary light quantities which is the ratio of the light quantities of light of the first wavelength band, light of the second wavelength band, and light of the third wavelength band required to secure a white balance, a distance of a light path from the light guiding unit to the second light source is shorter than a distance of a light path from the light guiding unit to the third light source, and the distance of the light path from the light guiding unit to the third light source is shorter than a distance of a light path from the light guiding unit to the first light source.

3. The light source device according to claim 1, wherein:
the light of the first wavelength band enters the first combining member from one side of the first combining member, and is reflected by the first combining member, and enters the first combining member from the other side different from the one side, again, and is reflected by the first combining member.

4. The light source device according to claim 2, wherein:
the light of the first wavelength band enters the first combining member from one side of the first combining member, and is reflected by the first combining member, and enters the first combining member from the other side different from the one side, again, and is reflected by the first combining member.

5. The light source device according to claim 1, wherein:
the light of the first wavelength band enters the first combining member from one side of the first combining member, and passes through the first combining member, and enters the first combining member from the other side different from the one side, again, and passes through the first combining member.

6. The light source device according to claim 2, wherein:
the light of the first wavelength band enters the first combining member from one side of the first combining member, and passes through the first combining member, and enters the first combining member from the other side different from the one side, again, and passes through the first combining member.

7. The light source device according to claim 1, wherein:
the first light source is laser diodes,
the second light source is a light emitting diode, and
the third light source is a rotary phosphor wheel which has a fluorescent area configured to be excited by light of the first wavelength band and emit light of the third wavelength band as fluorescent light, and a transmission area configured to transmit light of the first wavelength band, the fluorescent area and the transmission area being formed in a line in a circumferential direction.

8. The light source device according to claim 2, wherein:
the first light source is laser diodes,
the second light source is a light emitting diode, and
the third light source is a rotary phosphor wheel which has a fluorescent area configured to be excited by light of the first wavelength band and emit light of the third wavelength band as fluorescent light, and a transmission area configured to transmit light of the first wavelength band, the fluorescent area and the transmission area being formed in a line in a circumferential direction.

9. The light source device according to claim 7, further comprising:
a plurality of reflective mirrors that is configured to guide light of the first wavelength band having been reflected by the first combining member and having passed through the transmission area, to the first combining member,
wherein the first combining member reflects light of the first wavelength band and transmits light of the third wavelength band,
the second combining member transmits light of the first wavelength band and light of the third wavelength band having passed through the first combining member, and reflects light of the second wavelength band.

10. The light source device according to claim 7, further comprising:
a plurality of reflective mirrors that is configured to guide light of the first wavelength band having passed through the first combining member and having passed through the transmission area, to the first combining member,
wherein the first combining member transmits light of the first wavelength band and reflects light of the third wavelength band,
the second combining member transmits light of the first wavelength band and light of the third wavelength band having been reflected by the first combining member, and reflects light of the second wavelength band.

11. The light source device according to claim 9, wherein:
the total number of components of the first combining member, the second combining member, and the plurality of reflective mirrors to reflect or transmit light of the first wavelength band is larger than the total number of components to reflect or transmit light of the third wavelength band, and
the total number of components to reflect or transmit light of the third wavelength band is larger than the total number of components to reflect or transmit light of the second wavelength band.

12. The light source device according to claim 10, wherein:
the total number of components of the first combining member, the second combining member, and the plurality of reflective mirrors to reflect or transmit light of the first wavelength band is larger than the total number of components to reflect or transmit light of the third wavelength band, and
the total number of components to reflect or transmit light of the third wavelength band is larger than the total number of components to reflect or transmit light of the second wavelength band.

13. A light source device comprising:
a first light source that is configured to emit light of a first wavelength band;
a third light source that is configured to use the light of the first wavelength band as excitation light and that is configured to emit light of a third wavelength band;
a fourth light source that is configured to emit light of the wavelength band of the same color as the color of light of the first wavelength band;
a second light source that is configured to emit light of a second wavelength band which is different from the third wavelength band;
a first combining member that is configured to combine light of the third wavelength band and light emitted from the fourth light source; and
a second combining member that is configured to combine the combined light obtained by the first combining member and the light of the second wavelength band,
wherein the combined light obtained by the second combining member enters a light guiding unit.

14. The light source device according to claim 13, wherein:
the first light source is disposed on one side of the first combining member, and
the fourth light source is disposed on the other side of the first combining member facing the first light source with reference to the first combining member.

15. The light source device according to claim 13, wherein:
to keep the ratio of necessary light quantities which is the ratio of the light quantities of light of the first wavelength band, light of the second wavelength band, and light of the third wavelength band required to secure a white balance, a distance of a light path from the light guiding unit to the second light source is shorter than a distance of a light path from the light guiding unit to the third light source, and the distance of the light path from the light guiding unit to the third light source is shorter than a distance of a light path from the light guiding unit to the first light source.

16. The light source device according to claim 14, wherein:
to keep the ratio of necessary light quantities which is the ratio of the light quantities of light of the first wavelength band, light of the second wavelength band, and light of the third wavelength band required to secure a white balance, a distance of a light path from the light guiding unit to the second light source is shorter than a distance of a light path from the light guiding unit to the third light source, and the distance of the light path from the light guiding unit to the third light source is shorter than a distance of a light path from the light guiding unit to the first light source.

17. The light source device according to claim 1, wherein:
light of the first wavelength band is light of a blue wavelength band,
light of the second wavelength band is light of a red wavelength band, and
light of the third wavelength band is light of a green wavelength band.

18. The light source device according to claim 1, wherein:
a lens which is disposed on an emission side of the second light source is an aspheric plastic lens.

19. A projector comprising:
the light source device according to claim 1;
a display element that is configured to be irradiated with source light emitted from the light source device and that is configured to form image light;
a projection side optical system that is configured to project the image light emitted from the display element onto a screen; and
a control unit that is configured to control the display element and the light source device.

20. A projector comprising:
the light source device according to claim 13;
a display element that is configured to be irradiated with source light emitted from the light source device and that is configured to form image light;
a projection side optical system that is configured to project the image light emitted from the display element onto a screen; and
a control unit that is configured to control the display element and the light source device.
